(19) United States
(12) Patent Application Publication
(10) Pub. No.: US 2004/0249945 A1
(43) Pub. Date: Dec. 9, 2004

(54) Information processing system, client apparatus and information providing server constituting the same, and information providing server exclusive control method

(76) Inventors: Satoshi Tabuchi, Ibaraki (JP); Atsuhiko Fujimoto, Saitama (JP); Hiroyuki Suzuki, Kanagawa (JP)

Correspondence Address: William S. Frommer, Frommer Lawrence & Haug, 745 Fifth Avenue, New York, NY, 10151, US

(21) Appl. No.: 10/490,652

(22) PCT Filed: Sep. 27, 2002
(86) PCT No.: PCT/JP02/10112

(30) Foreign Application Priority Data
Sep. 27, 2001 (JP) 2001-297431

(51) Int. Cl. G06F 15/173

(52) U.S. Cl. 709/225; 709/203

(57) ABSTRACT

The present invention relates to an information processing system etc. well applicable to a network electronic conference system etc. It can prevent deadlock of the entire system and conduct good exclusive control without giving rise to a trouble which may occur when, for example, a time-out method is employed. An information providing server, when not in a locked state, gives access permission to one of a plurality of client apparatuses that has transmitted an access request to it and is put in the locked state and, based on information from the client apparatus, it is released from the locked state when an access termination operation of this client apparatus is completed or when the access termination operation cannot be performed normally.

The present invention is well applicable to exclusive control of an information processing system such as a network electronic conference system, a network education system, and a network game system.

### TECHNICAL FIELD

The present invention relates to an information processing system, a client apparatus and an information providing server that constitute the system, and method for exclusively controlling the information providing server that are well applicable to a network electronic conference system, a network education system, a network game system, etc. More specifically, it relates to an information processing system etc. having such a configuration that an information providing server, when not in a locked state, gives access permission to one of a plurality of client apparatuses that has transmitted an access request and is put in the locked state and, based on information obtained from the client apparatus, is released from the locked state when an access termination operation of this client apparatus is completed or the access termination operation cannot be performed normally, thereby preventing deadlock of the entire system and providing good exclusive control without giving rise to a trouble which may occur, for example, when a time-out method is employed.

### BACKROUND ART

Conventionally, a method for creating a lock file has been used as a method to provide exclusive control at a Web server in a network in such a system that a plurality of client apparatuses operates Web pages in the Web server in a network. For example, such an exclusive control method has been used that in a case where one of a plurality of client apparatuses accesses a Web server in a network to allow the Web server to open a Web page, such a method that the Web server creates a lock file to refuse access by another client apparatus is used as a method to provide exclusive control.

However, when this method is used simply, if for example a computer of the client apparatus hangs up for any reason, the lock file is left in the Web server so that no one can operate it thereafter. To solve this problem, such a time-out method may be conceivable that if no one is accessed after a constant lapse of time elapses, the lock file is eliminated.

As described above, when the method for creating the lock file is used simply, if a client apparatus, for example, hangs up for any reason, a lock file is left in a Web server, so that no one can operate it thereafter, thus giving rise to a deadlock state of the entire system, which is a problem.

Further, in a case where a time-out method for eliminating a lock file if no one is accessed after a constant lapse of time elapses is added to the above-mentioned method for creating a lock file, if a time-out lapse of time is set short, the lock file is eliminated, if a Web page is not operated within a constant period, despite that the Web page is in use after being opened, which is a problem. If the time-out lapse of time is set long, on the other hand, early detection of hang-up etc. of the client apparatus is impossible because abnormal decision is made only when no one is accessed within the constant period.

### DISCLOSURE OF THE INVENTION

In view of the above, it is an object of the present invention to provide an information processing system etc. that can prevent dead lock of the entire system and provide good exclusive control without giving rise to a trouble which may occur, for example, when a time-out method is employed.

An information processing system related to the present invention comprises an information providing server, and a plurality of client apparatuses each connected to said information providing server, wherein each of said client apparatuses includes monitoring means for monitoring operation of said information providing server, and wherein said information providing server includes lock control means for giving access permission to a client apparatus that has transmitted an access request, when the server being not in a locked state, the client apparatus being one of the plurality of client apparatuses, and making the server put in the locked state and, based on information obtained from the monitoring means of the client apparatus, making the server released from the locked state when an access termination operation of the client apparatus is completed or when the access termination operation cannot be performed normally.

A client apparatus related to the present invention that is connected to an information providing server, transmits access request to the information providing server, and access it after the access request is accepted, comprises monitoring means for monitoring operation of the information providing server.

An information providing server related to the present invention that is connected to a plurality of client apparatuses, comprises lock control means for giving access permission to a client apparatus that has transmitted an access request, when not in a locked state, the client apparatus being one of the plurality of client apparatuses, and making the server put in the locked state and, based on information obtained from the client apparatus, making the server released from the locked state when an access termination operation of the client apparatus is completed or when the access termination operation cannot be performed normally.

A method related to the present invention for exclusively controlling an information providing server in an information processing system comprising an information providing server and a plurality of client apparatuses each connected to the information providing server, comprising the steps of when the information providing server is not in a locked state, giving access permission to one of the plurality of client apparatuses that has transmitted an access request and putting the information providing server in the locked state, and based on information obtained from the client apparatus, releasing the locked state when an access termination operation of the client apparatus is completed or when the access termination operation cannot be performed normally.

According to the present invention, when not locked, the information providing server gives access permission to one of the plurality of client apparatuses that has transmitted an access request to it and is locked. To provide a locked state, a lock file is created, for example. Once being thus locked, the information providing server does not give access permission to any other client apparatuses even if they have transmitted an access request to it.

Further, when in the locked state, the information providing server is unlocked when an access termination operation of a client apparatus acquired the access permission is completed or when this client apparatus cannot perform the access termination operation. To release the locked state, a lock file is eliminated, for example. After being thus unlocked, the information providing server gives access permission to any other client apparatuses if they have transmitted an access request to it.

In such a manner, the information providing server is unlocked even if a client apparatus acquired the access permission cannot perform an access termination operation normally, thereby preventing deadlock of the entire system. Further, the present invention uses no time-out method for preventing deadlock of this entire system, thereby avoiding a trouble due to too short or too long time-out lapse of time. It is thus possible to provide good exclusive control.

### BRIEF DESCRIPTION OF THE DRAWINGS

FIG. 1 is a diagram for showing a configuration of a network electronic conference system;

FIG. 2 is a diagram for showing a configuration of a communicator;

FIG. 3 is a diagram for showing a configuration of a creator;

FIG. 4 is an illustration for showing a display screen of a client PC;

FIG. 5 is an illustration for showing a condition in which a menu of the creator is displayed;

FIG. 6 is an illustration for showing a contents manager screen;

FIG. 7 is a flowchart for showing system operations;

FIG. 8 is an illustration for showing a contents saving confirmation screen;

FIG. 9 is an illustration for showing a contents reproduction screen;

FIG. 10 is a block diagram for showing a configuration of an exclusive control system;

FIG. 11 is a flowchart for showing operations of a client PC 2 in an exclusive control mode; and

FIG. 12 is a flowchart for showing operations of a creator 1 in the exclusive control mode.

### BEST MODE FOR CARRYING OUT THE INVENTION

The following will describe a network electronic conference system according to an embodiment of the present invention.

For example, in the case of a network electronic conference system, an electronically created presentation material is transferred to a projector etc., which is a display, so that a conference may be advanced with the material zooming up. Therefore, the system as a whole is comprised of a computer (personal computer) acting as a client apparatus which manages presentation materials, an information processing assisting apparatus (having a personal computer configuration) used to transfer presentation materials to the display, etc., and the like.

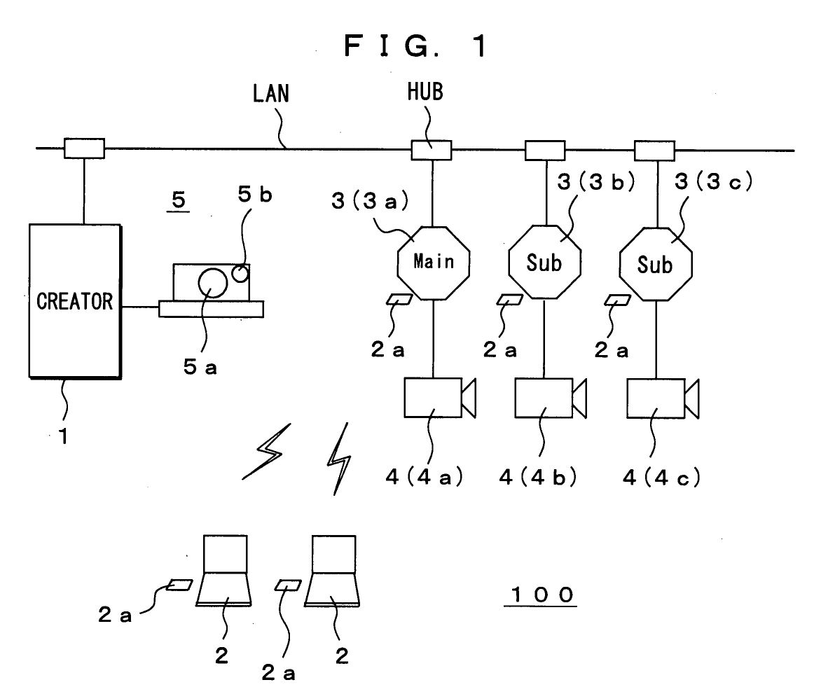

FIG. 1 shows a configuration of important portions of a network electronic conference system 100. This system 100 comprises client apparatuses (hereinafter referred to as client PCs) 2 for saving and managing presentation materials (file data) as described above, displays (hereinafter referred as projectors) 4 constituted of a projector etc. for projecting and displaying presentation materials, and information processing assisting apparatuses (hereinafter referred to as communicators) 3 constituted of personal computers for assisting the client PCs2 and the projectors 4 in data transmission/reception, data processing, etc. between them.

The client PCs 2 control the communicators 3, and images displayed on the video projectors 4 are controlled via the communicators 3. Therefore, each of the communicators 3 and each of the projectors 4 are connected to each other by an RGB cable etc.

The client PC2 and the communicator 3 are coupled with each other by communication means. Although the communication means may be of a wireless type or a wire type, the present embodiment employs the wireless type communication means.

Therefore, the client PC 2 and the communicator 3 are each equipped with a wireless LAN card 2a, which is a network interface card, to connect between them. Of course, even in the case of wireless communication, besides the wireless LAN card employed, an access point (not shown) may be used so that through this access point they may communicate with each other in configuration.

This network electronic conference system 100 further comprises an information providing server (hereinafter referred to as creator) 1, which is coupled by an LAN, for recording a condition of a conference room as images and voice and also recording presentation materials used in a relevant conference to create proceedings of the conference (conference contents). To the creator 1, there are connected a video camera 5a acting as a moving picture input apparatus and a microphone 5b acting as a voice input apparatus. A relevant moving picture/voice input apparatus 5 is connected directly to the creator 1 in such a configuration that its operation mode may be controlled in accordance with an instruction obtained from the client PC 2 in this example.

A main communicator 3a and the creator 1 respectively can perform communication between them and a conference between conference rooms installed at remote locations via a network such as the Internet. In this example, the creator 1 and the communicator 3 each have a global IP address of a same segment. It is no problem if the global IP addresses are of different segments. Note here that sub-communicators 3b and 3c each own a private IP address.

In the client PC 2, application software for an electronic conference and a Web browser are installed. Further, the client PC 2 has a monitor module 2A acting as monitoring means for monitoring Web pages. This monitor module 2A monitors a predetermined Web page when it is open and, if having detected that the Web page is finished, posts it to the creator 1. In one conference system, up to 16 PCs 2 can be used. When the plurality of client PCs 2 is used, they each have a unique private IP address set thereto.

In a case where the plurality of client PCs 2 is used, a closed environment is created in a relevant conference room and a common password are set to build up a conference system having secrecy such that an unspecific external third party form outside may not attend a conference or view contents of the conference.

This password can be freely set by a first conference attendee, so that the remaining conference attendees can enter this password to thereby attend this conference system.

One of the conference attendees transfers a presentation material from the client PC2 to the communicator 3 via the wireless LAN card 2a and displays it on the projector 4, thereby acquiring a right to make a presentation. The presentation right can be abandoned only by operating a function key on the client PC2 and handled over to any other conference attendees, so that all of the conference attendees have a qualification as a presenter.

Such a configuration is set up that one of the conference attendees may use the client PC2 to thereby control operation modes such as recording and reproduction for the creator 1. That is, this one conference attendee acquires a right to create materials for conference proceedings.

The following will describe components of the network electronic conference system 100.

In a most simple basic configuration, one conference room has one projector 4 installed in it and, therefore, the electronic conference system is built up by one communicator 3. However, there are some cases where to operate a conference efficiently, preferably a plurality of projectors 4 is used in advancing of the conference. This is because there are many cases where different presentation materials are displayed on the plurality of projectors 4 simultaneously and used in explanation.

In such a case, basically the communicators 3 are arranged in accordance with the number of the projectors 4 installed. FIG. 1 is a configuration example in which the three projectors 4 are used. In such a case where a plurality of communicators 3 is used, one of them is used as the main communicator 3a and the remaining two are used as the sub-communicators 3b and 3c.

In this case, such a control system is employed that presentation materials etc. sent from the client PC2 may be managed by the main communicator 3a and displayed through the sub-communicators 3b and 3c on projectors 4b and 4c, respectively. Therefore, the sub-communicators 3b and 3c each own a private IP address. It is also possible to control the plurality of communicators 3a, 3b, and 3c independently of each other.

The main communicator 3a has also such a function to, for example, send via a LAN to the creator 1 presentation materials themselves transferred from the client PC2 and information on the switchover of pages of these presentation materials (time when pages are turned over, page information, etc.) and receive information recorded in the creator 1 and deliver it to the client PC2 in accordance with an instruction obtained from the client PC2.

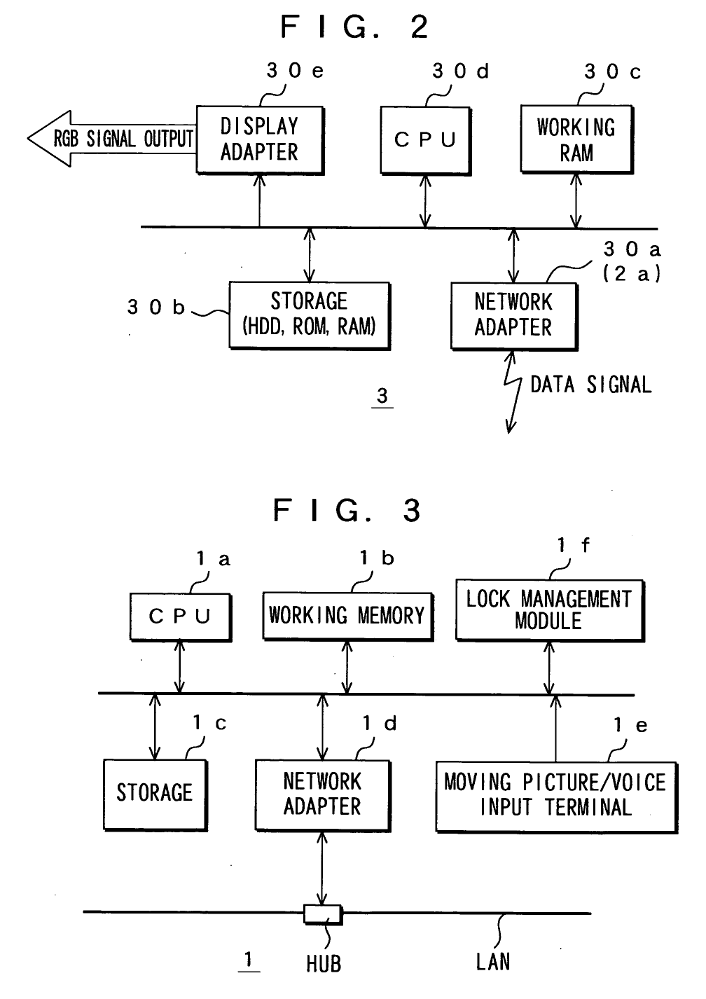

FIG. 2 shows a configuration of the communicator 3. As shown in FIG. 2, the communicator 3 is comprised of a network adapter 30a for transmitting presentation materials to and receiving them from the client PC2 as well as a storage 30b in which processing programs are stored, a working memory (working RAM) 30c, a CPU30d, and a display adapter 30e for outputting presentation materials in R, G, and B signals.

As the network adapter 30a, the above-mentioned wireless LAN card 2a is used in this example. In the storage 30b, there are stored basic software (electronic-conference application software) for operating the communicator 3 and processing programs for processing presentation materials.

The working RAM3c is used to temporarily accumulate received presentation materials and process these materials. The presentation materials are converted into the R, G, and B signals under the control of the CPU30d and supplied to the display adapter 30e. The projector 4 is connected to the communicator 3 through the RGB cable.

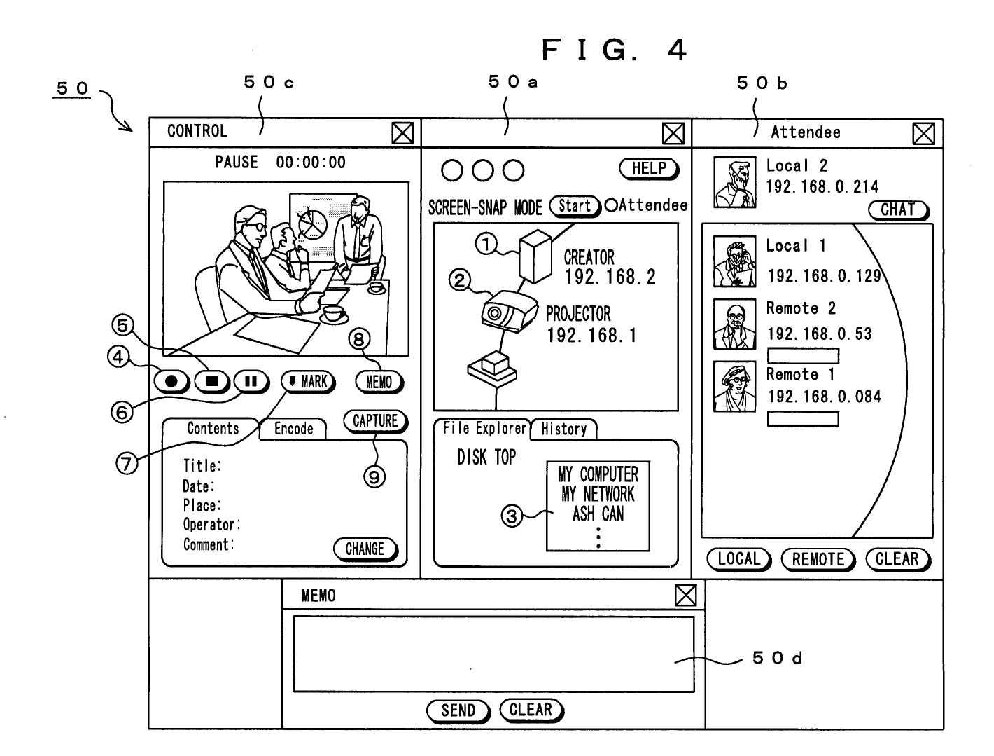

FIG. 3 shows a configuration of the creator 1. This creator 1 is comprised of a CPU1a for processing programs, a working memory (e.g., hard disk) for processing transmitted/received information (information of moving pictures, still pictures, etc.), a storage 1c for storing presentation materials as well as information of moving pictures, voice, etc. and a control program for processing them, a lock management module if for managing exclusive control of Web pages, and a network adapter id for connecting the communicator 3. The creator 1 further comprises a moving picture/voice input terminal (I/O interface) 1e for receiving moving picture/voice information from the moving picture/voice input apparatus 5 and controlling it.

The lock management module if gives access permission to such a client PC2 that has transmitted an access request first when not locked and creates a lock file to make a lock state. Further, if an access termination operation of this client PC2 is performed or the access termination operation cannot be performed normally because, for example, the client PC2 hangs up, the lock management module if eliminates the lock file and release the lock state.

This creator 1 records information about presentation materials being displayed on the communicator 3 as described above and also records information transferred from the communicator 3 such as information (information of IP addresses, facial portraits, etc.) of attendees of an electronic conference as well as moving picture/voice information etc. It also has a function to automatically create conference contents, which may be referred to as conference proceedings, when the recording is finished. How to automatically create the conference contents will be described later.

If the plurality of client PC2 is used as described above, the creator 1 and the moving picture/voice input apparatus 5 are controlled by one of these client PCs 2. That is, they are managed by the client PC acting as a clerical worker (hereinafter referred to as chronicler client PC) 2.

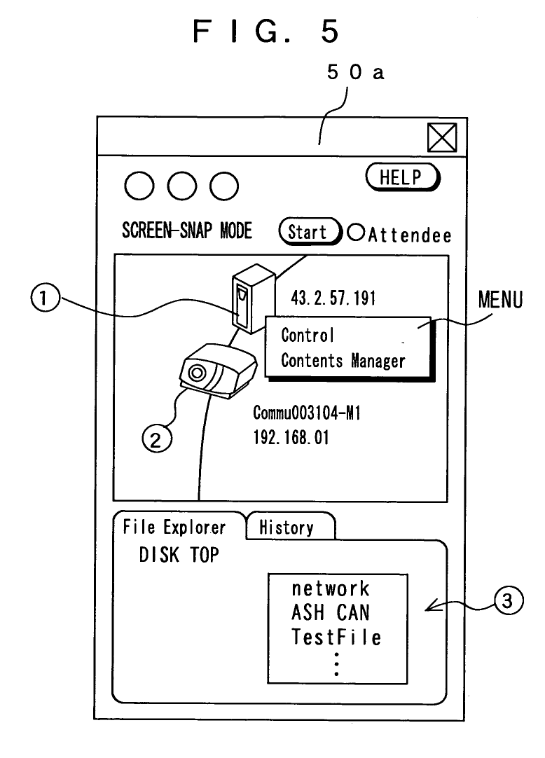

To become the client PC working as a clerical worker, it can open a control (CONTROL) screen which is used as an operating screen for the creator 1. FIG. 4 is an illustration for showing one example of a GUI screen 50, which is displayed on a display screen of the chronicler client PC.

This display screen 50 is composed of about three display screens divided horizontally, in a middle one of which a client PC-side basic screen 50a is displayed and on its right side an attendee screen 50b is displayed in which information about attendees of the conference is displayed and, on the left side of the basic screen 50a a control screen 50c for controlling the creator 1 is displayed. At the bottom of the screen, a horizontally long memo screen 50d is displayed.

At the upper part of the basic screen 50a, icons of devices connected to the electronic conference system are displayed. In the figure, an icon \mathring{1} of the creator 1, an icon \mathring{2} of the communicator 3, etc. are displayed. Although not assigned a reference symbol, an icon of the moving picture/voice input apparatus 5 is also displayed.

The lower part of the basic screen 50a is used as a file list field, where file names \mathring{3} accumulated in the client PC 2 that functions as a presenter are displayed.

On the attendee screen 50b, facial portraits of the attendees, private IP addresses of the client PCs 2 owned by the attendees, etc. are displayed.

On the control screen 50c, its top is used as an image display portion, where images shot by the video camera 5a are displayed as moving pictures. Its middle portion is a zonal display area acting as a portion where a plurality of soft keys including functions keys is operated and, its bottom is used as an input portion where titles etc. are entered. In the soft key operation portion, there are displayed a REC key \mathring{4}, a STOP key \mathring{5}, and a PAUSE key \mathring{6} as well as a MARK key \mathring{7} for marking important image portions in a record, a MEMO key \mathring{8} for opening the memo screen, a CAPTURE key \mathring{9} for saving still picture information (presentation materials) displayed on the projector 4, etc.

When the client PC 2 logs on the communicator 3, on its display screen only the basic screen 50a is displayed. By dragging a file in a file list \mathring{3} to the icon of the communicator 3 and dropping it there, data of the file (presentation material) can be transferred to the communicator 3 and displayed on the projector 4 and presented. However, this holds true with a case where these are operated on the side of the client PC 2 that has acquired a presenter's qualification.

When an Attendee button on the basic screen 50a is pressed, the attendee screen 50b is displayed on its right side as shown in FIG. 4.

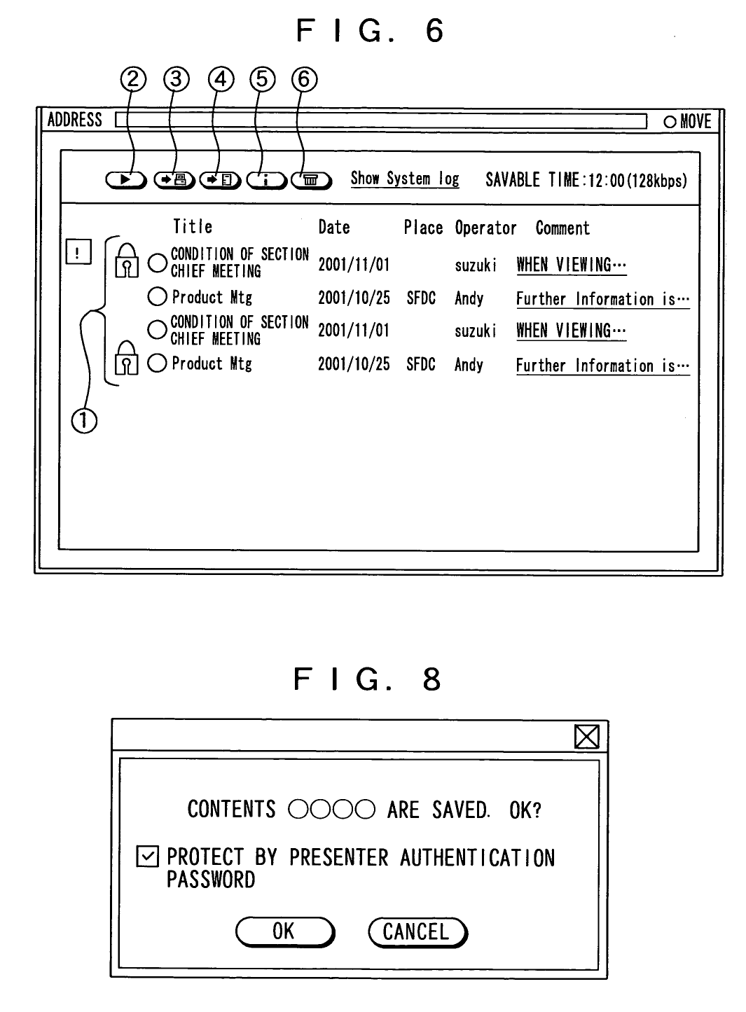

Then, when the creator icon is clicked on with the right mouse button, such a menu screen as shown in FIG. 5 is displayed, so that when “Control” is selected on this menu screen, the control screen 50c shown in FIG. 4 is displayed. When the MEMO key \mathring{8} is operated on the control screen, the memo screen 50d is displayed at a screen position in FIG. 4, where sentences etc. can be entered. The memo screen 50d occupies a space of four to six lines.

When “Contents Manager” is selected on the menu screen shown in FIG. 5, a list menu (creator contents manager screen) saved in the creator 1 is displayed.

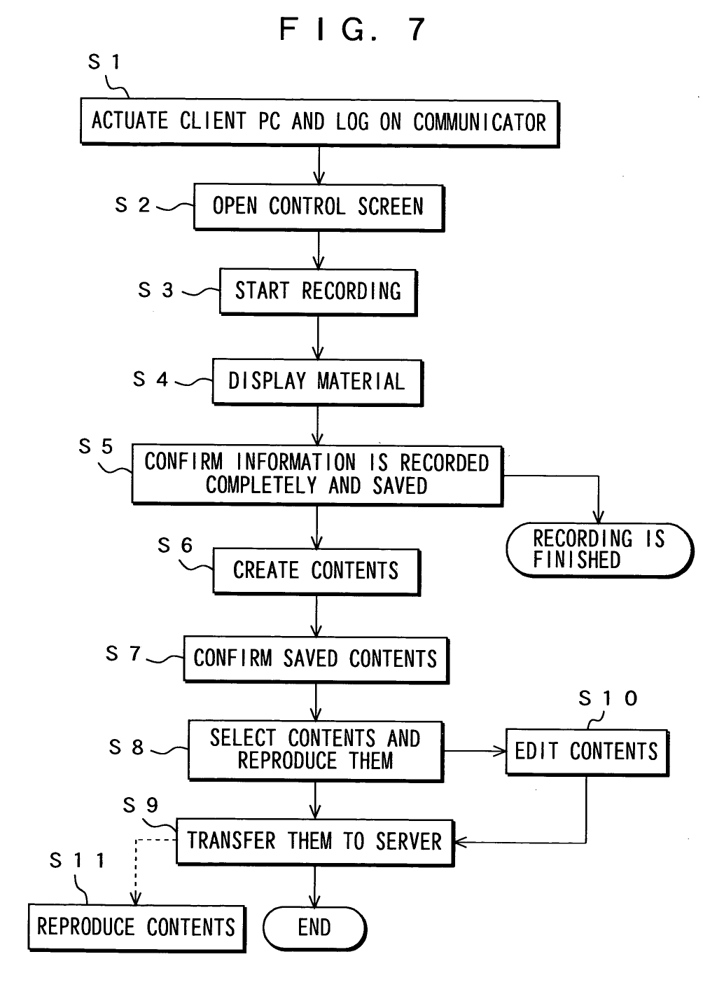

FIG. 6 shows a display example of this screen. On this screen, the contents list saved in the creator 1 and soft keys for selecting the operation mode for a selected contents list are displayed. In the present embodiment, there are displayed a Review key \mathring{2} for reproducing selected contents, a transfer-to-client key (Download to My Computer key) \mathring{3} for transferring selected contents to the client PC2, a transfer-to-server key (Upload to Server key) \mathring{4} for transferring selected contents to another server, a details key (Show Contents Information key) \mathring{5} for viewing details information of selected contents, a Delete key \mathring{6} for erasing selected contents, etc.

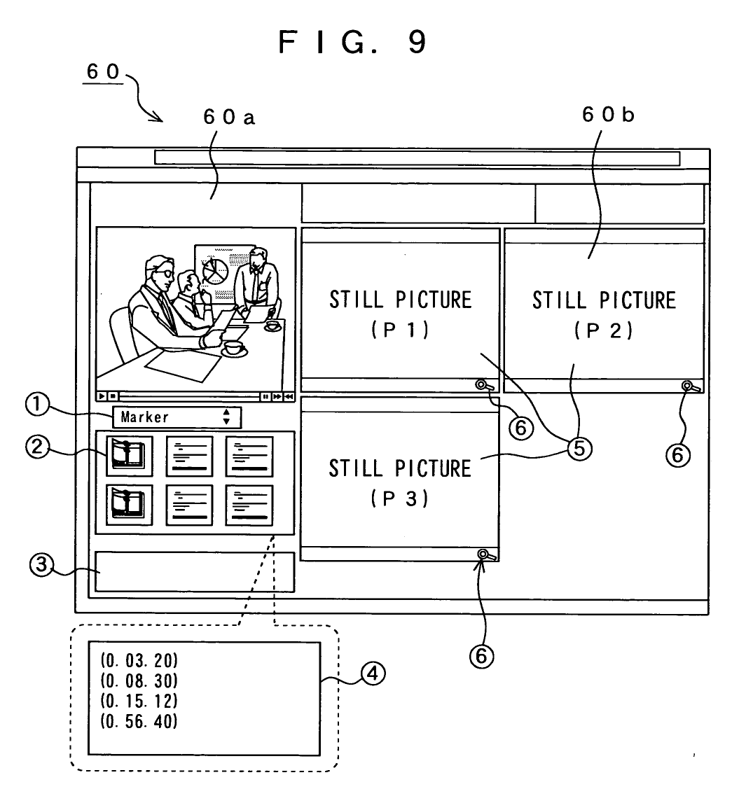

The following will describe operations of the above-mentioned network electronic conference system 100 with reference to FIG. 7.

First, at step S1, the electronic conference application software is activated using the client PC2 of a conference attendee, to log on the communicator (or the main communicator) 3.

In this case, as described above, a first conference attendee sets a password, so that attendees who follow him in time can enter this password to attend the conference. Since the password is not a unique value determined for the electronic conference system beforehand, it is possible to eliminate such a bad trouble that the electronic conference system cannot be activated because the password is forgotten or wrong.

At step S2, when any one of the conference attendees opens the control (CONTROL) screen 50c, which is the operation screen of the creator 1, only this client becomes the chronicler client PC (see FIG. 4).

If the icon \mathring{1} of the creator 1 (see FIG. 4) is clicked on with the right mouse button on GUI screen of the client PC 2 to select “CONTROL” from the displayed menu, the control screen 50c is displayed (see FIG. 4).

If the REC key \mathring{4} of the control screen (see FIG. 4) is pressed at step S3, the moving picture/voice input apparatus 5 is actuated to start recording images of the conference.

Further, if the MEMO key \mathring{8} (see FIG. 4) is pressed on the control screen 50c, the memo screen 50d such as shown in FIG. 4 is opened to enable entry of texts. If a SEND key is pressed, entered texts are taken into the creator 1.

If a presentation material is dragged from the file list \mathring{3} of the client PC2 to the icon \mathring{2} of the projector 4 on which the material is desired to be displayed and dropped there at step S4, the presentation material selected from the file list is displayed on the screen of the projector 4. At the same time, this presentation material, page switchover information, etc. are saved on the hard disk in the creator 1.

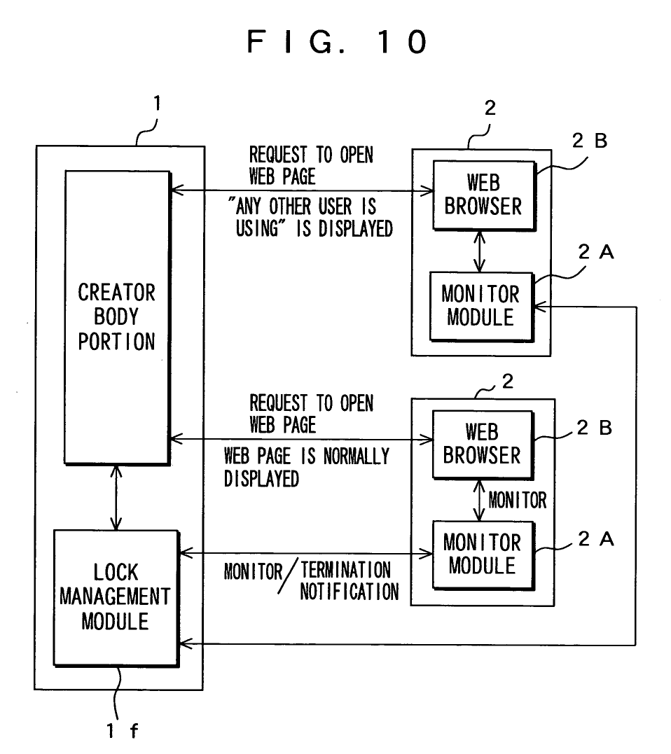

The STOP key \mathring{5} is pressed on the control screen at step S5 to finish recording. In this case, on the chronicler client PC2, a saving confirmation screen such as shown in FIG. 8 is displayed. Any contents are erased except for save processing. When information is saved, conference contents are automatically created at step S6. That is, at this step S6, conference contents are created on the basis of still picture information obtained from the communicator 3 and moving picture/voice information obtained from the moving picture/voice input apparatus 5. File data is converted into an HTML-format data so that the conference contents can be referenced via a network such as the Internet.

When creation of the conference contents is completed, the creator contents manager screen is displayed at step S7 so that the conference contents saved in the creator 1 can be confirmed (see FIG. 6).

By selecting desired conference contents on this creator contents manager screen at step S8, its details can be reproduced. The content whose details are confirmed is transferred to any other server to thereby be saved (step S9).

To reproduce conference contents and edit their details at step S8, on the other hand, the conference contents can be transferred to the side of the client PC2 by operating the creator contents manager screen and edited by using editing software at step S10. The server contents thus edited is transferred to the server and saved in there (step S9).

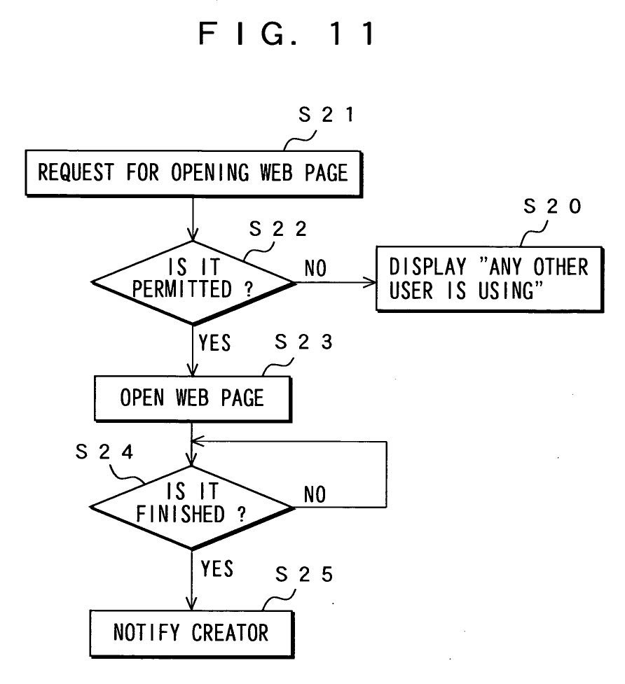

It is possible to reproduce the conference contents in the server from the chronicler client PC2 (step S1). FIG. 9 shows one example of a contents reproduction screen.

A contents reproduction screen 60 has such a screen configuration that a display screen is split into a moving picture reproduction portion 60a positioned at an upper left part for recording an image of a condition of a conference as shown in the figure and a still picture reproduction portion 60b positioned on its right half part for reproducing presentation materials constituted of still picture information used in the conference, thereby displaying these portions on the same display screen simultaneously.

Therefore, in the still picture reproduction portion 60b for reproduction of presentation materials, its display pattern changes with the maximum number of the projectors 4 installed in one conference room. The present embodiment has such a configuration that up to three projectors can be connected and so up to three sheets of presentation materials may be displayed, so that the still picture reproduction portion 60b has a display pattern in which the reproduction screen can be divided into four parts at the maximum.

This display pattern is formatted as a template, so that template-formatted display patterns (templates 1-3) can be selected in accordance with the number of projectors to be used. FIG. 9 shows a display example of a case of the template-3 display pattern, in which three projectors are used. A still picture P1 is a material \mathring{5} displayed through a projector 4a and, similarly, still pictures P2 and P3 is the material \mathring{5} displayed using the projectors 4b and 4c. In reproduction of contents, the material \mathring{5} displayed on this still picture reproduction portion 60b is automatically switched as time passes by.

In the moving picture reproduction portion 60a the above-mentioned image is displayed and, directly below its image display portion a View switchover portion \mathring{1} is displayed. A display portion \mathring{2} below it is divided into two stages, over which up to six sheets of presentation materials displayed through the projector are displayed in thumbnails. When a plurality of projectors is used, a material displayed through selected one of them is displayed in thumbnails.

When an arbitrary thumbnail is selected, a moving picture displayed above is synchronized with this to shift its thumbnail to displayed time, from which its normal reproduction starts.

This thumbnail display \mathring{2} can be switched to the above-mentioned mark display \mathring{4}. Switchover between thumbnail display and mark display is selected at the View switchover portion \mathring{1}. In order in which the MARK key \mathring{7} is pressed on the control screen 50c during a conference, titles (“Untitled” if no title is given) and times attached in edit processing are displayed. When a title in a mark display field \mathring{4} is clicked on with the mouse, a moving picture displayed above is shifted to its time in synchronization with it to perform normal reproduction. With this, a moving picture and a still picture (presentation material) are displayed in synchronization with each other always. In reproduction, displays are switched to each other as time passes by.

At the bottom of each of the display screens of the above-mentioned still picture reproduction portions 60b, a screen zoom-in button \mathring{6} is provided, so that when it is selected, a displayed still picture is switched into a maximum display pattern and displayed (original size display).

In the case of an electronic conference system in which a plurality of client PCs 2 is present as described above, according to exclusive control of the system, only one of the conference attendees can control the operation modes such as recording, reproduction, etc. for the creator 1 using the client PC 2.

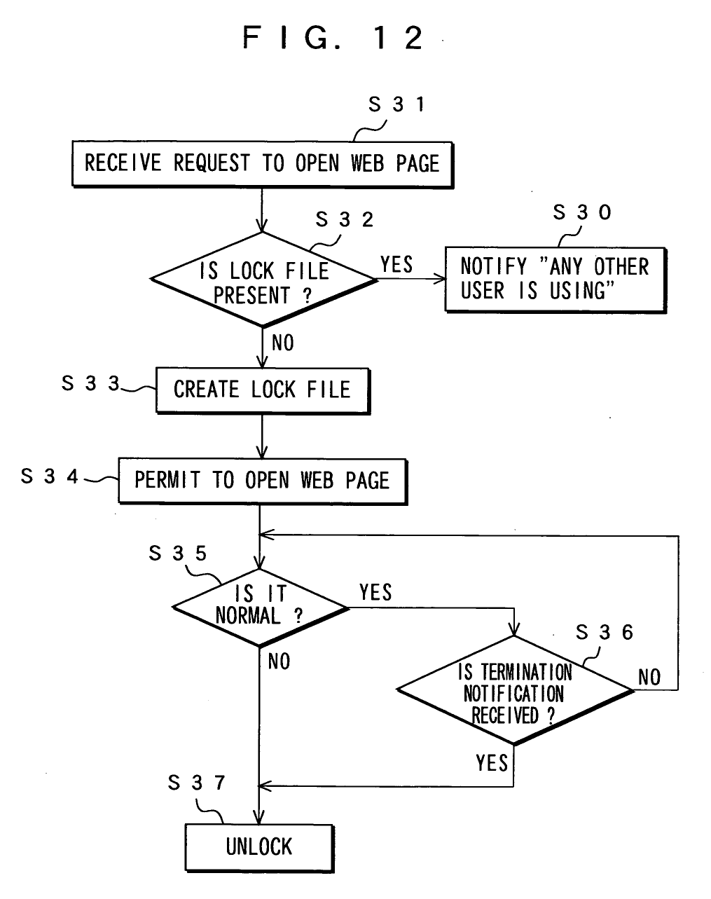

FIG. 10 is a block diagram for showing a configuration of an exclusive control system according to the present embodiment. In this case, the (two) client PCs 2 are coupled via the communicator 3 with the creator 1 by communication means. As shown in FIG. 10, in the creator 1 acting as an information providing server, the lock management module 1f is arranged which, for example, creates and eliminates lock files and monitors a client PC 2. Further, in the client PC 2, a Web browser 2B is installed. Further, the client PC 2 has the monitor module 2A for monitoring Web pages which are open in the Web browser 2B.

In the case of the network electronic conference system 100, in order to limit the number of the client PCs 2 acting as a clerical worker to one, a method is used for performing lock processing of the control (CONTROL) screen 50c as a Web page, which is an operation screen of the creator 1, and monitoring the control screen 50c at the client PC 2 and monitoring of the client PC 2 by use of the creator 1.

For example, when the client PC 2 has sent a request (access) to open the control screen 50c to the creator 1, first the creator 1 checks whether an already created lock file is present. If no already created file is present, the control screen 50c is opened and, at the same time, a lock file is created. When the lock file is thus created, the creator 1 is locked. Then, the client PC 2 periodically monitors the opened control screen 50c and, if it has detected that the control screen 50c is closed, the client PC 2 posts it to the lock management module if of the creator 1; when having received the notification, the lock management module 1f eliminates the lock file and releases a locked state, to release the control screen 50c to all of the client PCs2. Note here that when it is detected that the client PC2 has, for example, hung up, that is, an access termination operation cannot be performed normally, the locked state is eliminated and the control screen 50c is released to all of the client PCs2.

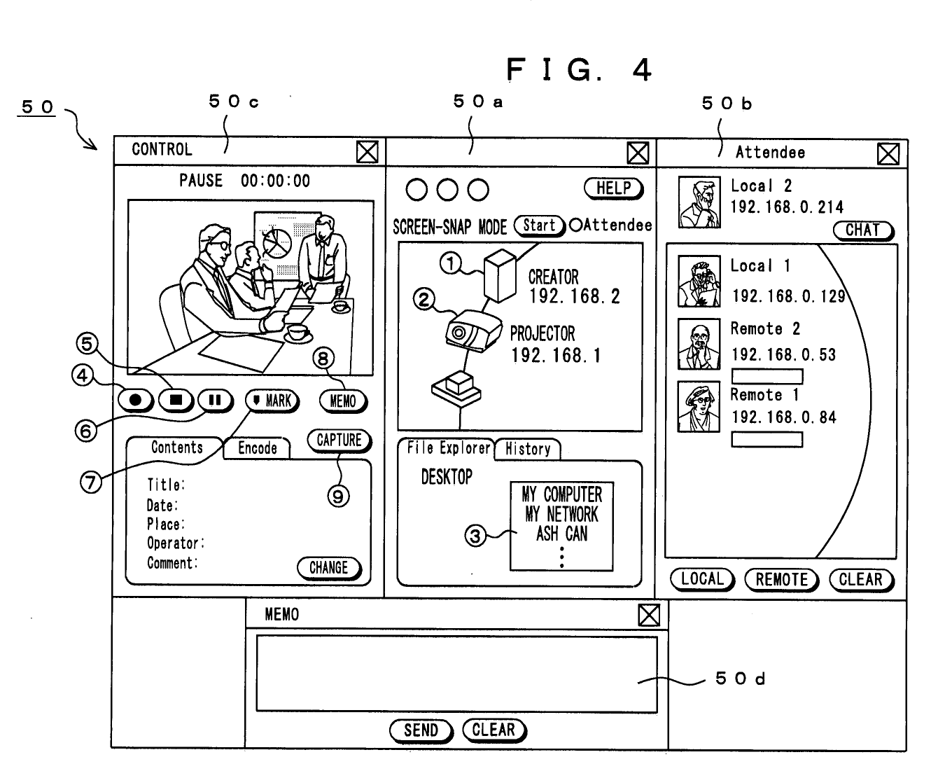

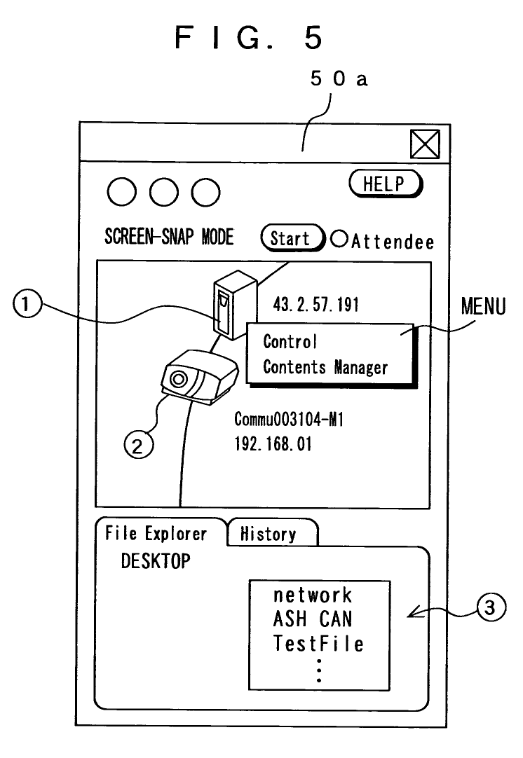

The following will describe exclusive control operations of the above-mentioned network electronic conference system 100 with reference to FIGS. 11 and 12.

FIG. 11 is a flowchart for showing operations of the client PC 2 in an exclusive control mode and FIG. 12 is a flowchart for showing operations of the creator 1 in the exclusive control mode.

First, the operations of the client PC 2 are described.

At step S21, for example, one of conference attendees transmits to the creator 1 a request to open the control screen (Web page) 50c using the client PC 2 as a chronicler.

At step S22, the process waits for a reply from the creator 1 and, if opening of the control screen 50c is not permitted (when the client PC2 of any other conference attendee is already using it), it displays that any other client (user) is using it at step S20. In this case, the control screen 50c cannot be opened. If opening of the control screen 50c is permitted, on the other hand, the process goes to step S23.

At step S23, the control screen 50c is opened. In this case, the creator 1 can be operated on the control screen 50c. For example, conference details can be, for example, recorded and reproduced.

At step S24, the monitor module 2A of the client PC2 monitors this control screen 50c periodically. In this case, the monitor 2A monitors, for example, information of titles etc. of the control screen 50c to decide whether the control screen 50c is in use. Further, when having detected that the control screen 50c is closed, it notifies the closure to the lock management module 1f at step S25. Then, the lock management module 1f of the creator 1 eliminates a lock file to release a locked state, thereby releasing the control screen 50c to all of the client PCs 2.

Next, the operations of the creator 1 are described.

First, at step S31, the creator receives a request to open the control screen (Web page) 50c in access from the client PC2.

Next, at step S32, it checks whether a lock file is present. If lock file is present already, it notifies of already use thereof. If no lock file is present, the process goes to step S33.

At S33, it creates a lock file.

Further, at step S34, it permits opening of the control screen 50c. Then, none of the other clients can open the control screen 50c.

Next, at step S35, the lock management module 1f of the creator 1 monitors the management module 2A of the client PC2 periodically. If a termination operation of the control screen 50c (termination of access) cannot be performed normally owing to hang-up etc. of the client PC 2 (abnormal case), it eliminates the lock file to release a locked state at step S37.

Further, if having received a termination notification of the control screen 50c from the client PC 2 at step S36, it eliminates the lock file to release the locked state at step S37. If no termination notification is received, on the other hand, it continues monitoring the lock management module 1f.

In the network electronic conference system 100, in a case where the number of persons who can operate the creator 1 simultaneously is limited to one according to the above-mentioned exclusive control method, when the person who is, for example, recording a conference has to be away from the desk on urgent business, even if he or she is involved in recording, he or she can close the control screen 50c and permit any other person to open it again, thus handing the operations over to the person without interrupting the recording operation.

In such a manner, when a request to open the control screen (Web page) 50c is sent from any one of the plurality of client PCs2 to the creator 1, first the creator 1 checks whether an already created lock file is present and, if no lock file is present, the control screen 50c is opened and a lock file is created simultaneously. When this control screen 50c is open, the process performs periodic monitoring of the control screen 50c by the client PC 2 and, if having detected that the control 50c is closed and finished, this (access operation having been performed) is notified to the lock management module 1f, which in turn eliminates the lock file to release the locked state, thereby releasing the control screen 50c to all of the client PCs 2. It is thus possible to securely perform exclusive control processing by limiting the number of client PCs 2 that can operate the control screen 50c simultaneously to one in the network electronic conference system 100 in which there is the plurality of client PCs 2.

Further, monitoring of the client PC 2 by the lock management module 1f of the creator 1 is periodically performed when the control screen 50c is in use and, if it is detected that the control screen 50c cannot be closed normally (i.e., access termination operation cannot be performed) owing to hang-up etc. of the client PC2, the lock management module 1f eliminates a lock file to release a locked state, thereby preventing deadlock of the entire system to conduct stable exclusive control.

Another application example of the above-mentioned embodiment may be such that, for example, in a typical conference application, a Web server is provided with a Web page and a person who opens this page acts as a “chairman” and, by closing this page and permitting another person to open it, can hand over “chairman authority” to him or her.

Although in the above embodiment, the present invention has been applied to a network electronic conference system, the present invention is not limited to it. For example, the present invention can be applied similarly to a network education system, a network game system, etc.

Further, in the above embodiment, exclusive control of a system in lock processing of the control (CONTROL) screen 50c, which is an operation screen of the creator 1, has been described. Exclusive control is not limited to it and can be applied also to operations and functions that need any other type of exclusive control in the information providing server.

Further, in the above-mentioned embodiment, the information providing server has given access permission to a client apparatus that has transmitted an access request first and locked it, thereby conducting exclusive control. This type of exclusive control is not limited to this example but may be such that only a terminal registered beforehand is given access permission. Further, only a terminal at which a specific password is entered may be given access permission.

Further, although in the above embodiment, the creator 1 acting as an information providing server has handled as information a Web page having a format that can be displayed by a Web browser, the present invention can be applied similarly to such an embodiment as to handle any other information.

Further, although in the above embodiment, the client PC2 has accessed the creator 1 through the communicator 3, the present invention is not limited to it. The present invention can be applied to such an embodiment that, for example, the client PC2 directly accesses the creator 1 using wire or wireless communication means.

According to the present invention, an information providing server, when not in a locked state, gives access permission to one of a plurality of client apparatuses that has transmitted an access request to it and is put in the locked state and, if an access termination operation of this client apparatus is performed or if the access termination operation of this client apparatus cannot be performed normally, the information providing server releases the locked state, thereby preventing deadlock of the entire system and providing good exclusive control without giving rise to a trouble which may occur, for example, when a time-out method is employed.

### INDUSTRIAL APPLICABILITY

In such a manner, an information processing system related to the present invention, its constituent client apparatus and information providing server, and a method for exclusively controlling the information providing server are well applicable to, for example, a network electronic conference system, a network education system, a network game system, etc.

1. An information processing system comprising:
an information providing server; and
a plurality of client apparatuses each connected to said information providing server,
wherein each of said client apparatuses includes monitoring means for monitoring operation of said information providing server; and
wherein said information providing server includes lock control means for giving access permission to a client apparatus that has transmitted an access request, when said server being not in a locked state, said client apparatus being one of said plurality of client apparatuses, and making the server put in the locked state and, based on information obtained from said monitoring means of said client apparatus, making the server released from said locked state when an access termination operation of said client apparatus is completed or when said access termination operation cannot be performed normally.

2. The information processing system according to claim 1, wherein operation of said information providing server is related to a control screen and said client apparatus controls the operation of said information providing server based on said control screen.

3. The information processing system according to claim 1, wherein said lock control means creates a lock file when providing said locked state and eliminates said lock file when releasing said locked state.

4. The information processing system according to claim 2, wherein when a network electronic conference is held using said information providing server, said client apparatus given access permission becomes a client apparatus acting as a clerical worker for controlling recording operation for recording information of said network electronic conference of said information providing server.

5. The information processing system according to claim 2, wherein when a network electronic conference is held using said information providing server, said client apparatus given access permission becomes a client apparatus acting as a chairman for supervising proceeding of said network electronic conference.

6. A client apparatus connected to an information providing server, for transmitting access request to the information providing server and accessing it after the access request is accepted, comprising monitoring means for monitoring operation of the information providing server.

7. The client apparatus according to claim 6, for controlling operation of said information providing server based on information for control screen display obtained from said information providing server.

8. An information providing server connected to a plurality of client apparatuses, comprising lock control means for giving access permission to a client apparatus that has transmitted an access request, when not in a locked state, said client apparatus being one of the plurality of client apparatuses, and making said server put in the locked state and, based on information obtained from said client apparatus, making said server released from the locked state when an access termination operation of the client apparatus is completed or when the access termination operation cannot be performed normally.

9. The information providing server according to claim 8, wherein said lock control means creates a lock file when providing said locked state and eliminates said lock file when releasing said locked state.

10. A method for exclusively controlling an information providing server in an information processing system comprising the information providing server and a plurality of client apparatuses each connected to the information providing server, said method comprising the steps of:
when the information providing server is not in a locked state, giving access permission to a client apparatus that has transmitted an access request, said client apparatus being one of said plurality of client apparatuses, and putting the information providing server in the locked state; and
based on information obtained from said client apparatus, releasing the locked state when an access termination operation of said client apparatus is completed or when the access termination operation cannot be performed normally.
